(19) United States
(12) Patent Application Publication
(10) Pub. No.: US 2007/0053462 A1
(43) Pub. Date: Mar. 8, 2007

(54) SAMPLING FREQUENCY OFFSET ESTIMATION AND CORRECTION SYSTEM AND METHOD FOR ULTRA WIDEBAND OFDM

(76) Inventors: Ali D. Pirooz, Fremont, CA (US); Catherine A. French, Olympia, WA (US); Ruoyang Lu, Milpitas, CA (US); Hung C. Nguyen, Milpitas, CA (US)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/467,158

(22) Filed: Aug. 24, 2006

Related U.S. Application Data
(60) Provisional application No. 60/714,703, filed on Sep. 6, 2005.

(51) Int. Cl. H04B 15/00

(52) U.S. Cl. 375/285

(57) ABSTRACT

A system and method that uses pilot tones to determine a phase estimate to adjust the phase of a sampling clock of an analog-to-digital converter (ADC) to compensate for sampling frequency offset between the ADC in a receiver and a digital-to-analog converter in a transmitter.

### PRIORITY REFERENCE TO PRIOR APPLICATIONS

This application claims benefit of and incorporates by reference U.S. patent application Ser. No. 60/714,703, entitled “NOVEL SAMPLING FREQUENCY OFFSET ESTIMATION AND CORRECTION IN UWB/OFDM,” filed on Sep. 6, 2005, by inventors Ali D. PIROOZ et al.

### TECHNICAL FIELD

This invention relates generally to ultra wideband, and more particularly, but not exclusively, provides a system and method for sampling frequency offset estimation and correction in analog-to-digital converters.

### BACKGROUND

A digital communications system requires digital-to-analog converters (DACs) on the transmit side, and analog-to-digital converters (ADCs) on the receive side in order to interface between the digital and analog domains. In an ideal system, the DACs and ADCs would run off of identical clocks. In a real system, the transmit and receive clocks may have slightly different frequencies, and this difference is referred to as sampling frequency offset (SFO). An effective receiver must correct for this offset.

There are two main conventional approaches to correction of SFO. The first approach is to estimate the frequency offset itself, and then correct the frequency via feedback to a variable-frequency ADC clock. This method generally results in the best performance, but requires a variable-frequency clock rather than a fixed oscillator.

The second approach is to estimate the phase shift caused by the frequency offset, then correct for the phase shift by rotating the received samples and by adding or dropping a sample periodically to compensate for the phase offset. Note that adding or dropping a sample corresponds to making a phase adjustment of ±360 degrees in the ADC sampling clock. This method, called Add/Drop or Rob/Stuff, has the advantage that the ADC clock can have a fixed frequency, and that the correction can be done purely in the digital domain. The trade-off is that performance is degraded to some extent compared to the frequency adjustment method.

Accordingly, a new system and method are needed that improves SFO correction without the use of variable-frequency clock.

### SUMMARY

Embodiments of the present invention extend the Add/Drop method to include phase adjustments smaller than 360 degrees. Because the phase adjustments are finer than for Add/Drop, system performance is improved since fractional adjustments to the clock phase are made instead of adding or dropping a whole sample at a time. This improves performance because the offset is corrected before it becomes too large. In an embodiment, a smaller phase shift of 360/N degrees is allowed, where N is an integer (typically 2, 4 or 8). This requires that a phase-locked loop (PLL) that controls the sampling clock be designed to produce one of N clock phases. However, the sampling frequency can remain fixed.

Embodiments of the present invention also include an option for reverting to the Add/Drop method if a phase-adjustable ADC clock is not available to the digital receiver. This is accomplished with only minimal additional circuitry, thus providing for an efficient and flexible design.

In an embodiment, the SFO correction method may be implemented for the multiband orthogonal frequency division multiplexed (OFDM) system described in one of the physical layer standards proposed for IEEE 802.15.3a Personal Area Networks. The proposed standard comes from the WiMedia Alliance and can be found on their website: www.wimedia.org.

In the WiMedia standard, data samples are encoded and then mapped to complex tones or subcarriers. A total of 128 subcarriers form an OFDM symbol, which serves as input to an inverse fast Fourier transform (IFFT) that functions as the OFDM modulator. Not all subcarriers contain data; some contain guard tones, null tones, or pilot tones. Pilot tones are fixed complex numbers inserted at specific locations or subcarrier numbers. On the receive side, these known pilot tones can be used for various functions including SFO correction. The present invention uses this type of pilot-based SFO correction.

In the WiMedia standard, there are 12 pilot tones per OFDM symbol, located at the following subcarrier numbers (assuming the first subcarrier is numbered as 0):
Upper Pilot Locations: 5, 15, 25, 35, 45, 55
Lower Pilot Locations: 73, 83, 93, 103, 113, 123

The upper and lower pilots are located symmetrically with respect to each other within the OFDM symbol, which is an important attribute when the pilots are used by the receiver.

In an embodiment of the invention, a sampling frequency offset system that compensates for different clock frequencies in a transmit digital-to-analog converter and a receive analog-to-digital converter comprises a sampling frequency offset block and a sampling frequency offset feedback control. The sampling frequency offset block generates a phase estimate based on pilot tones of a received symbol. The sampling frequency offset feedback control, which is coupled to the block, adjusts a PLL coupled to an analog-to-digital converter based on the generated phase estimate.

In an embodiment of the invention, a method of compensating for different sampling frequencies in a transmit digital-to-analog converter and a receive analog-to-digital converter, comprises: receiving a symbol; generating a phase estimate based on pilot tones of the received symbol; and adjusting a PLL coupled to an analog-to-digital converter based on the generated phase estimate.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a receiver incorporating a SFO correction block according to an embodiment of the invention;

FIG. 2 is a block diagram illustrating estimation and rotation performed by the SFO block of the receiver of FIG. 1;

FIG. 3 is a flow chart illustrating the operation of the SFO feedback control block;

FIG. 4 is a block diagram illustrating a Pilot block of the receiver of FIG. 1; and

FIG. 5 is a block diagram illustrating a multichannel receiver according to an embodiment of the invention.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

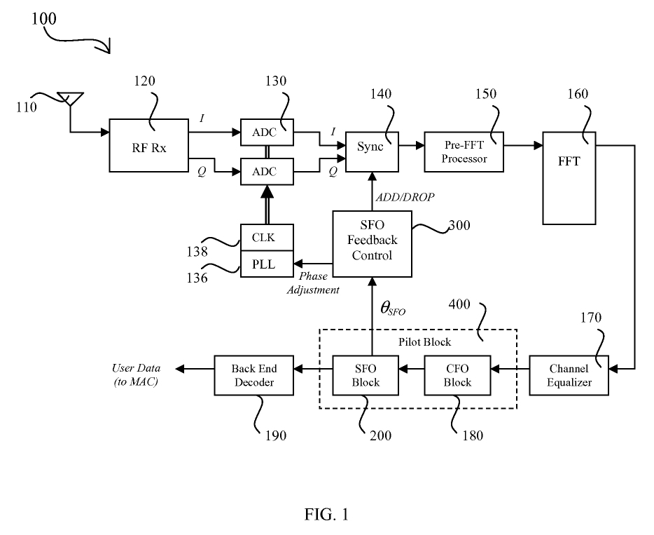

FIG. 1 is a block diagram illustrating a receiver 100 incorporating a SFO correction block according to an embodiment of the invention. The receiver 100 comprises a receiving antenna 110 coupled to an analog radio frequency (RF) receiver 120. The RF receiver 120 produces in-phase (I) and quadrature (Q) analog signals which enter substantially identical ADCs 130. The resulting digital I/Q signals enter a synchronization block 140, which achieves packet detection and symbol and frame boundary location. The sync block 140 is coupled to a pre-FFT processing block 150, which is in turn coupled to a FFT 160, which achieves OFDM demodulation. The output of the FFT 160 enters a channel equalizer 170, followed by a carrier frequency offset (CFO) block 180, and a SFO block 200. Conventionally, SFO correction is generally implemented in parallel with the CFO correction and the equalization. In the present invention, the SFO correction is performed after the equalizer and CFO, resulting in improved performance. The CFO and SFO blocks together are referred to as a Pilot block 400, because they both utilize the pilot tones. The SFO block 200 is coupled to both a back end decoder 190 and to a SFO feedback control block 300. The back end decoder 190 produces the decoded user data that is sent to the Media Access Control layer (MAC). The SFO feedback control 300 uses the phase estimate, OSFO, from the SFO block 200 to produce control signals to the synchronizer 140 and to a PLL 136 that controls a sampling clock 138 to the ADCs 130. The system can operate in one of two modes depending on whether a phase-adjustable sampling clock is available. With a phase-adjustable clock, the system can be set to PLL mode, whereby the SFO feedback controller 300 sends adjustment signals to the PLL 136. With a fixed-phase clock, the system should be set to Add/Drop mode, whereby the SFO feedback controller 300 sends adjustment signals to the sync 140.

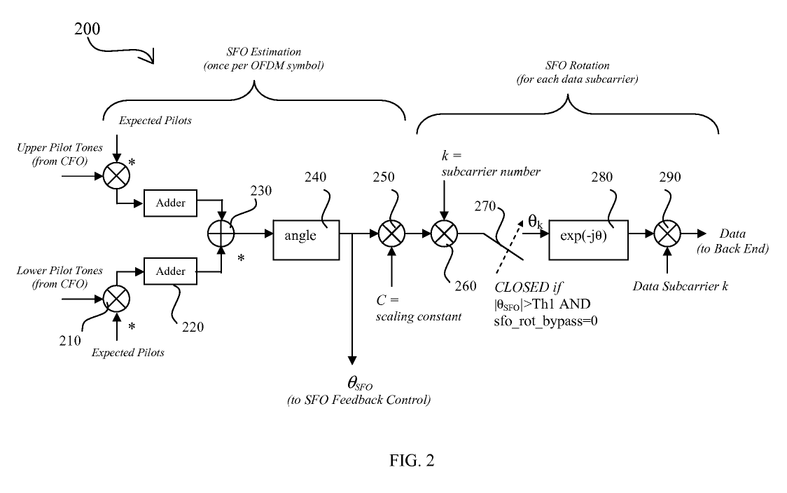

FIG. 2 is a block diagram illustrating estimation and rotation performed by the SFO block 200. The received upper and lower pilot tones are compared to the expected tones via complex multipliers 210. If this is performed by the CFO block 180, it can be skipped in the SFO block 200. The upper and lower modified pilots then enter complex adders 220 to sum the upper and lower values separately. The upper sum is then added to the complex conjugate of the lower sum, via another complex adder 230. The angle of the resulting complex number is determined, and the output of the angle block 240 is the estimate to be sent to the SFO feedback control block 300. Estimation is performed once per OFDM symbol using the 12 pilot tones from that symbol. The second half of the SFO block performs rotation of each of the data samples in the symbol, and begins by multiplying 250 the estimate, OSFO, by a factor C, typically around 0.04. The result is further multiplied 260 by the subcarrier number, k, corresponding to the data sample to be rotated. The subcarrier multiplier output 260 is coupled to a switch 270 which is controlled by signals indicating whether the estimate has crossed a first threshold, Thl, and whether rotation is turned on (i.e., sfo rot bypass=0). The threshold is typically set to about Th1=0.1 radians. When the system is in PLL mode, it may be desirable to turn off the SFO rotation. This features allows flexibility, particularly during prototype and test of the design. If the switch 270 is closed, the scaled estimate enters a block that converts an angle, θ, to a complex number, exp(−jθ) 280, which is then used to rotate the data subcarrier via a complex multiplier 290.

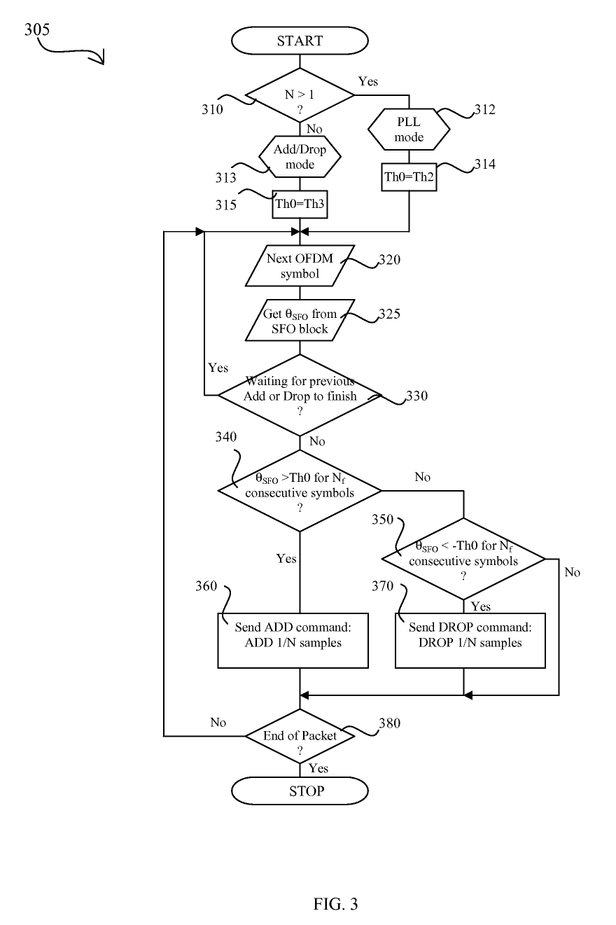

FIG. 3 is a flowchart illustrating the operation 305 of the SFO feedback control block 300. The operation 305 starts with a test 310 to determine the amount of resolution, N, in the phase adjustment, with N>1 indicating PLL mode 312 and N=1 indicating Add/Drop mode 313. The design of the PLL that controls the sampling clock determines the exact value of N in PLL mode, with a typical value being 2, 4 or 8. If the system is in Add/Drop mode 313, a threshold, Th0, is set equal to a stored value of Th3 315, typically equal to 0.7 radians. If the system is in PLL mode, the threshold for use by the block is set to a different level, Th2 314, with the exact value determined by the value N. In either mode, the SFO control block begins its main loop by proceeding to the next OFDM symbol 320 and receiving the phase estimate, θ_{SFO}, 325 from the SFO block 200. Next there is a test to determine whether the control block is waiting for one of its previous adjustments to take affect 330. This test is important in ensuring that any adjustments made by the sync 140 in Add/Drop mode or by the PLL 136 in PLL mode have a chance to settle before further adjustments are requested by the SFO feedback controller 300. Typically the waiting period would be 3-5 symbols, but would depend on the latency in the system. If the system is not waiting for a previous adjustment to finish, the controller compares the estimate to the threshold, Th0, checking whether Nf consecutive threshold crossings have occurred 340. Here, Nf is an integer number of OFDM symbols, typically about 3. The inclusion of consecutive threshold crossings in this test helps to limit false alarms in the adjustments. The block also tests for crossings of the negative of Th0, also requiring Nf consecutive crossings 350. For Nf crossings of the positive threshold, the control block sends out an Add command to add 1/N samples 360. In Add/Drop mode, this means that the sync 140 is asked to move the symbol boundary 1 sample earlier. In PLL mode, an Add command instructs the PLL to move the clock edge 1/N earlier instead of moving the symbol boundary. Similarly, for Nf crossings of the negative threshold, the control block sends out a Drop command to drop 1/N samples 370. In Add/Drop mode, a Drop command instructs the sync 140 to move the symbol boundary 1 sample later. In PLL mode, a Drop command instructs the PLL to move the clock edge 1/N later. The process returns to the start of the main loop until no symbols remain in the packet 380. The operation 305 then ends.

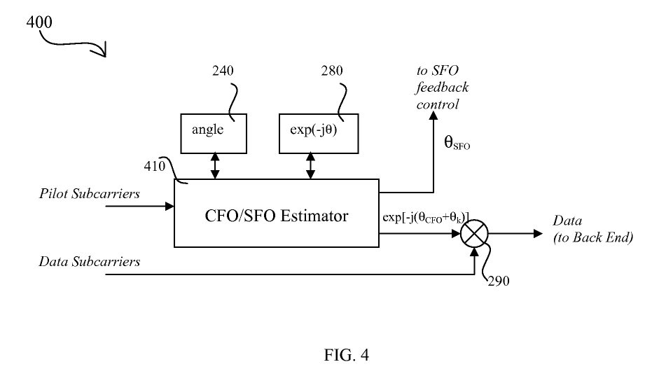

FIG. 4 is a block diagram of the Pilot block 400, illustrating how the SFO block 200 and the CFO block 180 can share circuitry. The pilot subcarriers enter a combined CFO/SFO estimator 410. The calculations performed for the SFO estimation are exactly as shown in FIG. 2. The calculations performed for the CFO estimation can be found in the literature, and would be familiar to one skilled in the art. The CFO and SFO calculations both require an angle function 240 and an exp(−jθ) function 280, so the CFO/SFO estimator 410 is directly coupled to both of these blocks. The combined estimator shares these two functions for reduced implementation complexity. In addition, both the CFO block 180 and the SFO block 200 require a rotation of the incoming data samples. The rotation angle for the SFO correction is ok, where k is the subcarrier number. For the CFO correction, the rotation angle is θ_{CFO}, independent of the subcarrier number. Both corrections are performed at once using a complex multiplier 290 with inputs equal to the data subcarrier and exp[−j(θ_{CFO}+θₖ)].

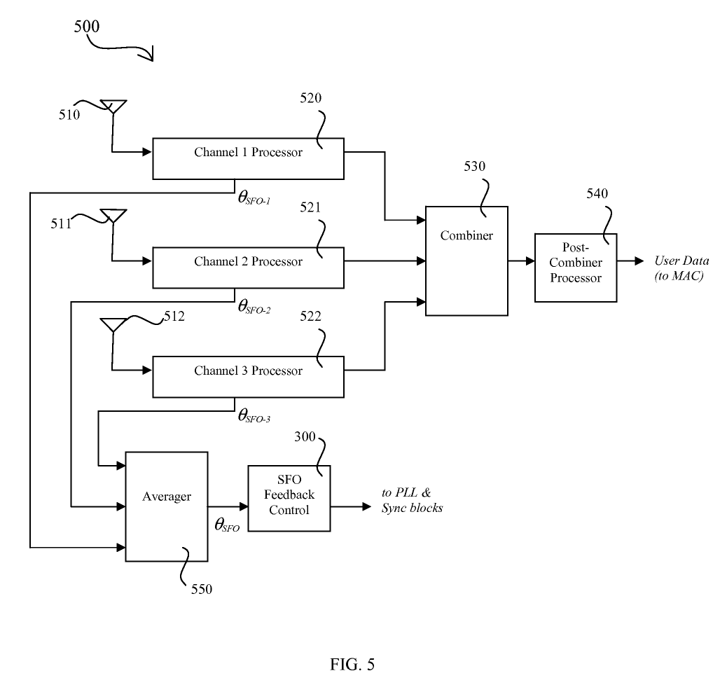

FIG. 5 is a block diagram illustrating a multichannel receiver 500 according to an embodiment of the invention. Multiple SFO block 200 outputs can be combined into one set of adjustments for each of the receiver chains in a multichannel system 500. Incoming signals are received by one of M antennas 510, 511, 512, where M=3 is shown. The signals on each antenna are processed by analog and digital blocks 520, 521, 522, which are coupled to a combiner 530 that creates a single receive path. A post-combiner processor 540 further decodes the signal to produce user data. If the channel 1, channel 2, and channel 3 processors 520, 521, 522 utilize the same sampling clock and if the SFO block occurs before the combiner 530, the SFO estimates from each path, referred to as θ_{SFO}-1, θ_{SFO}-2, and θ_{SFO}-3, can be averaged 550 and the average used by a single SFO feedback control block 300. The average creates a more robust estimate, improving the accuracy of the SFO adjustment.

The foregoing description of the illustrated embodiments of the present invention is by way of example only, and other variations and modifications of the above-described embodiments and methods are possible in light of the foregoing teaching. For example, SFO adjustment can be used with other wireless technologies besides UWB. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method of compensating for different frequencies in a transmit digital-to-analog converter and a receive analog-to-digital converter, comprising:
receiving a symbol;
generating a phase estimate based on pilot tones of the received symbol; and
adjusting a PLL coupled to an analog-to-digital converter based on the generated phase estimate.

2. The method of claim 1, further comprising rotating each of the data samples in the symbol based on the phase estimate.

3. The method of claim 1, wherein the PLL is adjusted in increments of less than 360 degrees.

4. The method of claim 1, wherein a sampling frequency is maintained at a fixed frequency during the adjusting.

5. The method of claim 1, wherein the generating comprises generating phase estimates for the symbol as received on multiple channels and averaging the estimates to generate an averaged estimate for use in the adjusting.

6. The method of claim 1, wherein the receiving, generating, and adjusting is repeated once per symbol.

7. The method of claim 6, wherein the adjusting occurs when a number of consecutively generated estimates cross a threshold.

8. The method of claim 1, further comprising performing carrier frequency offset correction before the generating.

9. The method of claim 1, wherein the generating comprises:
comparing upper and lower pilot tones of the received pilot tones;
summing the modified upper and lower pilot tones;
adding the complex conjugate of the lower sum to the upper sum;
determining the angle of the resulting complex number, wherein the angle is the phase estimate.

10. A system for compensating for different frequencies in a transmit digital-to-analog converter and a receive analog-to-digital converter, comprising:
means for receiving a symbol;
means for generating a phase estimate based on pilot tones of the received symbol; and
means for adjusting a PLL coupled to an analog-to-digital converter based on the generated phase offset.

11. A sampling frequency offset system that compensates for different frequencies in a transmit digital-to-analog converter and a receive analog-to-digital converter, comprising:
a sampling frequency offset block capable of generating a phase estimate based on pilot tones of a received symbol; and
a sampling frequency offset feedback control, coupled to the block, capable of adjusting a PLL coupled to an analog-to-digital converter based on the generated phase estimate.

12. The system of claim 11, wherein the block is further capable of rotating each of the data samples in the symbol based on the phase estimate.

13. The system of claim 11, wherein the PLL is adjusted in increments of less than 360 degrees.

14. The system of claim 11, wherein a sampling frequency is maintained at a fixed frequency during the adjusting.

15. The system of claim 11, further comprising an averager capable of generating phase estimates for the symbol as received on multiple channels and averaging the estimates to generate an averaged estimate for use in the adjusting.

16. The system of claim 11, wherein the block and feedback control repeat the receiving, generating, and adjusting once per symbol.

17. The system of claim 16, wherein the feedback control adjusts the PLL when a number of consecutively generated estimates cross a threshold.

18. The system of claim 11, wherein the sampling frequency offset block comprises:
a first set of complex multipliers that compare upper and lower pilot tones of the received pilot tones;
a first set of comlex adders that sum the modified upper and lower tones separately;
a complex adder that adds the upper sum to the complex conjugate of the lower sum; and
an angle block that determines the angle of resulting complex number, wherein the angle is the phase offset.

19. The system of claim 11, further comprising a carrier frequency offset block coupled to the sampling frequency offset block, wherein the carrier frequency offset block implements carrier frequency offset correction before the sampling frequency offset block implements sampling frequency offset calculations.

20. The system of claim 19, wherein the carrier frequency offset block and the sampling frequency offset block share an angle function and a complex exponent function.

21. A receiver incorporating the system of claim 11.

22. The receiver of claim 11, further comprising an add/drop mode that is active when the PLL is not phase-adjustable.
